(19) United States
(12) Patent Application Publication
(10) Pub. No.: US 2005/0146487 A1
(43) Pub. Date: Jul. 7, 2005

(54) Binocular virtual display imaging device

(75) Inventors: Paul J. Travers, Honeoye Falls, NY (US); Paul J. Churnetski, West Henrietta, NY (US); Stephen J. Glaser, Pittsford, NY (US); David Vogler, Rochester, NY (US); James Gresko, Rochester, NY (US); Scott Leathersich, Henrietta, NY (US)

Correspondence Address: Stephen B. Salai, Esq.;Harter, Secrest & Emery LLP, 1600 Bausch & Lomb Place, Rochester, NY, 14604-2711, US

(73) Assignee: Interactive Imaging Systems, Inc., Rochester, NY (US)

(21) Appl. No.: 10/752,746

(22) Filed: Jan. 7, 2004

(51) Int. Cl. G09G 5/00

(52) U.S. Cl. 345/8

(57) ABSTRACT

An imaging device for operably disposing a virtual display in front of each eye of a user and an optional speaker attachable to the imaging device. The imaging device of the present invention includes a binocular frame for securing the imaging device to the user including two adjustable bows such that the virtual display of the imaging device is adjustable and pivotable to at least two viewing positions with respect to the line of sight of the user.

### BACKGROUND OF THE INVENTION

1. Field of the Invention

The present invention relates to a binocular virtual display imaging device, and more particularly, to an imaging device supporting a virtual display in front of both eyes wherein the imaging device is sufficiently coupled to the head to be easily adjustable to at least two viewing positions and to optionally include an audio device.

2. Description of Related Art

Current display supports have employed a helmet that includes a mounted visor. These generate discomfort if worn for extended periods of time and also are difficult to stabilize and thus they make it difficult for the user to keep the virtual display at the correct location for optimum viewing. There is a need for a personal virtual display that is smaller and more comfortable to use a current alternatives and allow the viewer to see large images that are not cut-off.

Therefore, the need exists for a lightweight BINOCULAR VIRTUAL DISPLAY IMAGING DEVICE to allow a user to optimize the virtual display being viewed while being able to view other items in a non-immersive environment as well as being relatively simple to adjust and stabilize.

### BRIEF SUMMARY OF THE INVENTION

The imaging device of the present invention includes a binocular frame for securing the imaging device to the user including two adjustable bows such that the virtual display of the imaging device is adjustable and pivotable to at least two viewing positions with respect to the line of sight of the user.

### BRIEF DESCRIPTION OF THE SEVERAL VIEWS OF THE DRAWING(S)

FIG. 1 is a perspective view of an IMAGING DEVICE.

FIG. 2 is a front view of the IMAGING DEVICE.

FIGS. 3a-c is a side view of the IMAGING DEVICE.

FIG. 4 is a front view of the front frame on the nose of a viewer.

FIGS. 5a-c is another side view of the IMAGING DEVICE in the second position.

FIG. 6 is a view of the IMAGING DEVICE with earpiece.

FIG. 7 is a top view of the IMAGING DEVICE.

FIG. 8 is a view of the earpiece with a speaker.

### DETAILED DESCRIPTION OF THE INVENTION

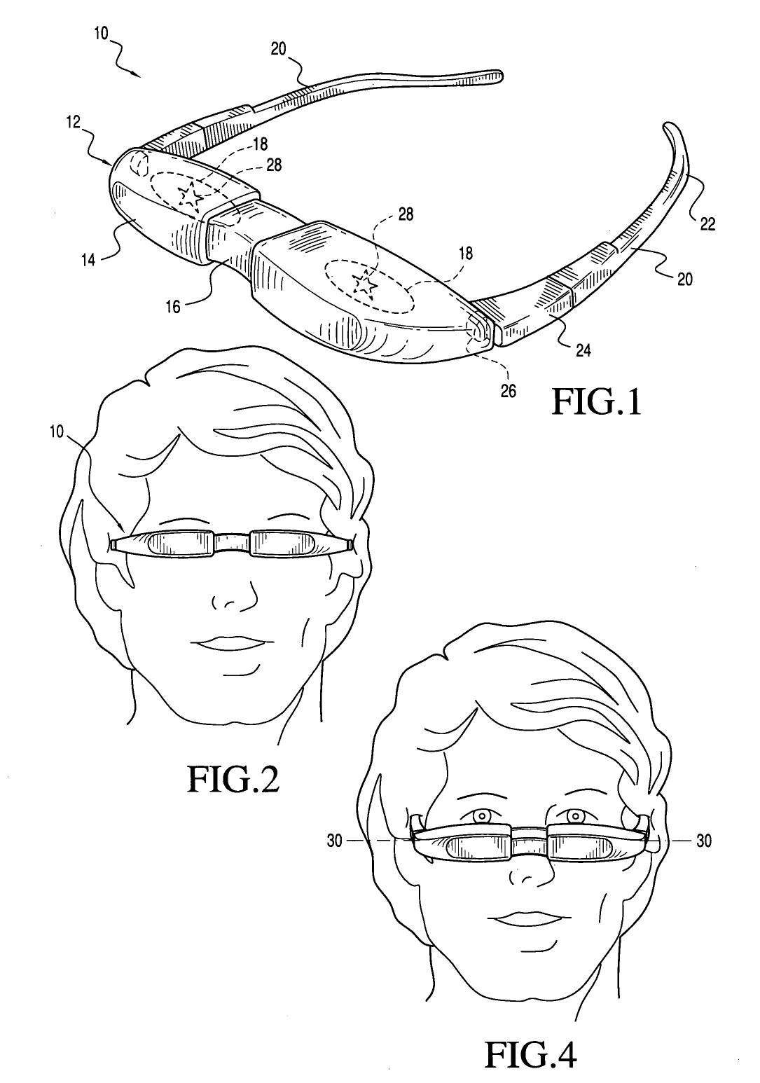

FIGS. 1 and 2 show a binocular virtual display imaging device 10, hereafter referred to as imaging device 10. The imaging device 10 includes a binocular frame 12, including a front frame 14 and a nose piece 16 for supporting an optical assembly 18, including a display engine, for each eye. The binocular frame 12, shown supports one optical assembly 18 in front of each eye preferably a micro display such as the one described in the co-pending application MICRO DISPLAY ENGINE owned by the same assignee. The binocular frame 12 could alternatively support one display engine with a means to project an image to each eye through electronic or optical means. The binocular frame 12 attaches to a pair of bows 20. Each bow 20 has a back piece 22, a front piece 24, and a pivotal connector 26. The optical assemblies generate a virtual display 28.

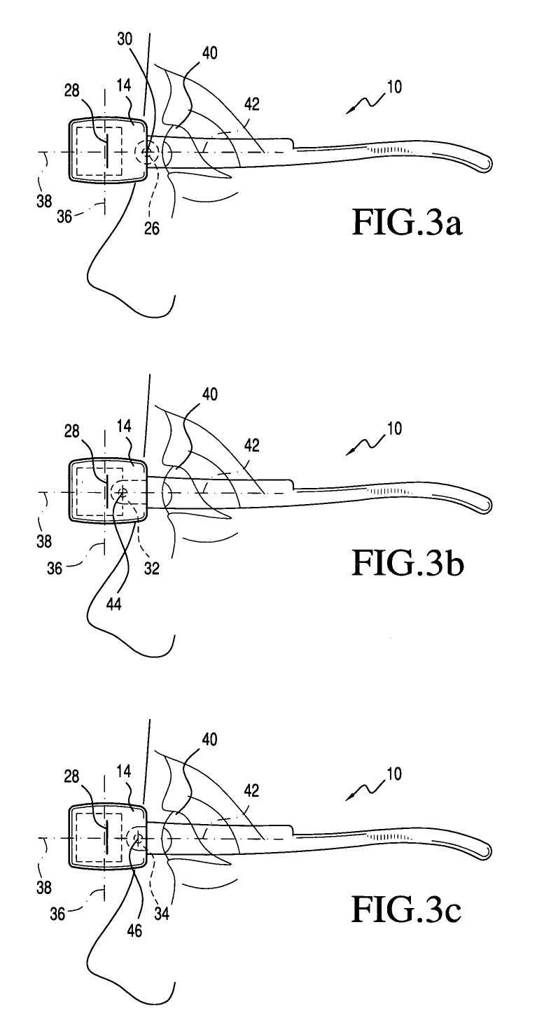

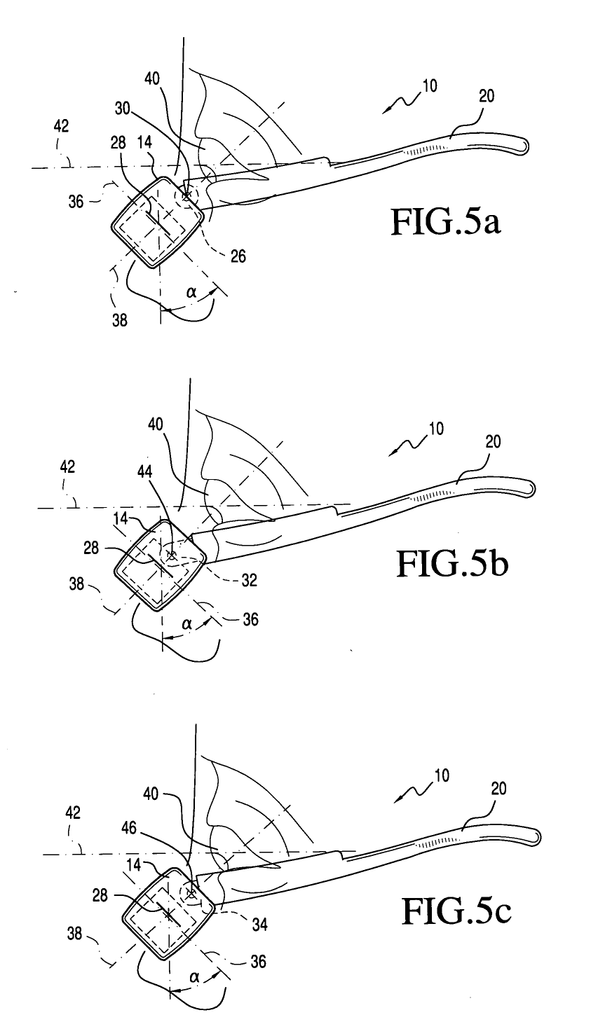

As shown in FIG. 1, the imaging device 10 is designed for bimodal use between immersive and non-immersive environments. Although both eyes can view the virtual displays 28, it is possible to adjust the virtual display 28 above or below the viewer's eyes so that the user can continue to monitor the environment. The user can further monitor the environment or even primarily monitor the environment while still viewing the display by the angular adjustment feature that allows the displays to be moved out of a first line of sight (FIG. 3), and be tilted into a second line of sight as shown in FIGS. 4 and 5.

FIG. 3a shows a side view of the imaging device 10 including the pivotable connector 26 which has a pivotal axis 30 (see FIG. 4). The optical assembly 18 is located within the front frame 14 with the pivotal connector 26 between the front frame 14 and the bows 20. In other embodiments a pivotal connection 32 could be located in the optical assembly 18 as shown in FIG. 3b or a pivotal connection 34 may be in the frontframe 14 but not in the optical assembly as shown in FIG. 3c. FIGS. 3a, 3b, and 3c show a display plane 36 and a line 38 normal to the display plane 36. The present invention allows a user's eye 40 to maintain an image in a line of sight 42 that is coincident with line 38 and thus normal to the display plane 36. This keeps the image from being clipped and reduces eye strain.

FIGS. 5a-c show a side view of the front frame 14 at an angled position as it is pivoted around axis 30 such that the optical assembly 18 is now at an angle to the bow 20 as would happen if the imaging device 10 was moved down the nose of the user looking down through the imaging device 10 in a manner similar to the use of reading glasses. The display plane 36 has moved through an angle α, maintaining the user's line of sight nominally normal to the display plane 36. This feature allows angular adjustment of optical assembly 18 about the axis 30 as it is slid down the user's nose, allowing the user to continue viewing the virtual display(s) 28 on center as shown in FIGS. 4 and 5. This allows viewing in both an immersive and non-immersive environment. The addition of eye caps or a shroud would allow a user the chance to be in an entirely immersive environment. Thus, allowing for a relaxed immersive and non-immersive experience without image clipping or eyestrain. Alternatively, the optical assembly can be pivoted about axis 44 (FIG. 5b) or the front frame about axis 46 (FIG. 5c).

There may be other related modifications that will enhance the viewer's ease of adjustment and comfort. They include other pivotable positions and points beyond the bow pivots for carrying out this invention. For example, changes in the bridge or in the bows themselves beyond their interconnection with the front frame could be made by additional adjustments at their joints. Alternatively, it may be possible to articulate the bows to pivot the optical assemblies within the front frame to obtain a similar result. The bows could have a translational adjustment on the bow to allow the front frame to be moved translationally with respect to the front frame.

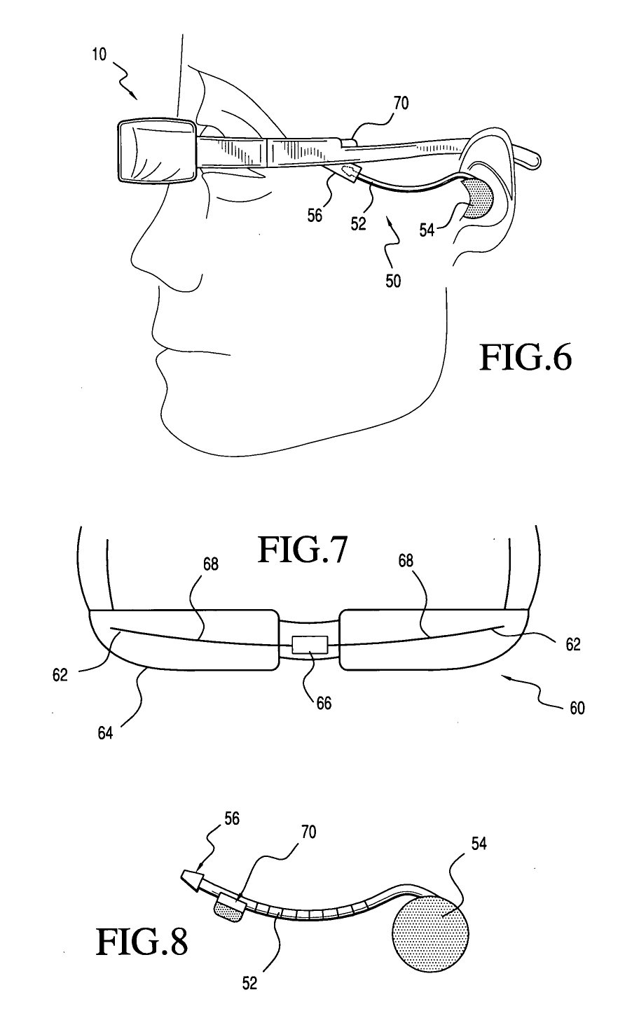

FIG. 6 shows an earpiece 50 attached to the bow 20 of the imaging device 10. The earpiece 50 allows an audio addition by combining an earpiece 50, such as the boom-mounted earpiece 50, shown on the binocular imaging device. The addition of a boom 52, which could be a flexible boom, and a speaker 54 such as a suspended speaker for the binocular virtual display imaging device 10 allows the user to receive audio signals. Since the binocular imaging device 10 is of the type that fits on the head, similar to eyeglasses, it is very comfortable. The frame supports a separate display for each eye. The frame 12 can be made with permanent speakers in at least one of the bows but this requires that the speaker(s) is chosen in advance or built in. The embodiment shown in FIG. 6 allows the end user to choose a speaker. Since at least one of the bows 20 includes an ear phone jack receptacle 56 for communicating audio output. The earpiece 50 or earphone can be plugged into the jack 56 for producing audio output.

FIG. 7 shows another embodiment of the binocular virtual display IMAGING DEVICE 60 where the connection 62 is in the front frame 64 where there is one image generator 66 or engine as a “bi-ocular” display design 68 that only uses one virtual display engine as discussed in the co-pending application MICRO DISPLAY ENGINE owned by the same assignee.

FIG. 8 shows the speaker 54 on the end of the flexible boom 52. One end of the flexible boom 52 is plugged into the jack receptacle and the other end has the speaker 54. The flexible boom 52 can be a FLEXIPIPE can be bent to adjust the position of the speaker to the user's ear. The imaging device 10 could have two audio jacks, one could be for stereo. Optionally, there could be a microphone 70 connected by the same jacks or a separate jack. The microphone 70 could also be built into the bow.

The invention has been described in detail with particular reference to certain preferred embodiments thereof. It will be understood that variations in modifications ca be affected within the spirit and scope of the present invention.

1. A binocular virtual display imaging device, the imaging device comprising:
a. a frame front for supporting an optical assembly with a display plane;
b. a bow connected to the frame front; and
c. a pivotal connection between the bow and the frame front, the pivotal connection adjustable between at least two user viewing positions, each viewing position such that the display plane of the optical assembly is located nominally normal to the user's line of sight.

2. The imaging device of claim 1 further comprising a translational adjustment on the bow to allow the frame front to be moved translationally.

3. The imaging device of claim 1 further comprising an adjustment device on the nose piece.

4. The imaging device of claim 1 further comprising a limit to limit pivotal movements.

5. A binocular virtual display imaging device, the imaging device comprising:
a. frame front for supporting an optical assembly with a display plane;
b. a bow connected to the frame front; and
c. a pivotal connection in the frame front, the connection adjustable between at least two user viewing positions, each viewing position such that the display plane of the optical assembly is located nominally normal to the user's line of sight.

6. The imaging device of claim 5 further comprising an adjustment device on the nosepiece.

7. The imaging device of claim 5 further comprising a translational adjustment on the bow to allow the front frame to be moved translationally.

8. The imaging device of claim 5 further comprising a limit to limit pivotal movements.

9. A binocular virtual display imaging device, the imaging device comprising:
a. frame front for supporting an optical assembly with a display plane;
b. a virtual display with an image on a display plane generated by the optical assembly;
c. a bow connected to the frame front; and
d. a pivotal connection in the frame front on the optical assembly, the connection adjustable between at least two user viewing positions, each viewing position such that the display plane of the optical assembly is nominally normal to the user's line of sight.

10. The imaging device of claim 9 further comprising a translational adjustment on the bow to allow the front frame to be moved translationally.

11. The imaging device of claim 9 further comprising an adjustment device on the nose piece.

12. The imaging device of claim 9 further comprising a limit to limit pivotal movements.

13. A non-immersive binocular virtual display imaging device, the imaging device comprising:
a. binocular frame front for supporting a virtual display with an image plane;
b. a bow connected to the frame front at an axis point;
c. a pivotal connection in the frame front, the connection adjustable between at least two user viewing positions, each viewing position such that image plane of the virtual display is located within the user's line of sight.

14. The imaging device of claim 13 further comprising an adjustment device on the nosepiece.
